(19) United States
(12) Patent Application Publication
(10) Pub. No.: US 2008/0178633 A1
(43) Pub. Date: Jul. 31, 2008

(54) Avatar Image Processing Unit and Washing Machine Having the Same

(75) Inventors: Seong Hae Jeong, Gyeongsangnam-do (KR); Byung Hwan Ahn, Gyeongsangnam-do (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/667,451

(22) PCT Filed: Jun. 28, 2006
(86) PCT No.: PCT/KR06/02502

§ 371 Date: Oct. 10, 2007

(30) Foreign Application Priority Data
Jun. 30, 2005 (KR) 10-2005-0058246
Jun. 30, 2005 (KR) 10-2005-0058247
Jun. 30, 2005 (KR) 10-2005-0058248

(51) Int. Cl. G06F 3/048; G06F 3/16; D06F 33/02

(52) U.S. Cl. 68/12.23; 715/772; 715/761; 715/727; 68/12.27

(57) ABSTRACT

The present invention relates to an avatar image processing unit applicable to various kind of electronic products for representing information on operation or control of the product with an avatar, and a washing machine having the same applied thereto. The avatar image processing unit of the present invention applied to a home appliance enables to represent a basic direction of use, and states of operation progress and control with mobile characters. The voice presentation related to movement of the avatar enables more accurate transmission of information, which enhances visibility of information to improve information transmission performance, and permits to put emphasis on an entertainment factor of the present consumer trend. A variety of representation is possible by downloading and storing new avatar from a server with an external device, which permits a variety of operation state representations proper for operation conditions, thereby enhancing competitiveness of the product.

### TECHNICAL FIELD

The present invention relates to an avatar image processing unit applicable to various kinds of electronic products for representing information on operation or control of the product with an avatar, and a washing machine having the same applied thereto.

### BACKGROUND ART

In general, home appliances are sold to consumers, and used by the consumers for a long time by operation of the consumers, that influences reliability of the manufacturer and the product, directly. Accordingly, in order to provide accurate product information to the consumers of a variety of classes, many means are suggested.

The product information, including direction of use, countermeasures for malfunctions, and information on an operation state displayed during operation of the product, is provided in a manual for consumers in a step of shipment of the product, presently.

### DISCLOSURE OF INVENTION

### Technical Problem

However, in general, such a manual fails to be means for providing proper information when required because it is a trend that the user does not read the manual carefully except a case the product is out of order, and it is difficult to keep the manual.

Moreover, in general, a representation of the present state on operation progress or control of the product is a light flashing or characters displayed, on a small screen, not on a large screen, too.

Particularly, in a case a remote monitor unit applicable to a home appliance which has a remote control function by using a home network and a radio communication is used, the information to be provided to the user is limited.

Accordingly, it is difficult to represent a variety of operation states for various operation conditions of the home appliance.

Such a related art type of product information transmission, is made on the assumption that the user pays attention to it, yet has, not only a poor information transmission capability, but also difficulty in updating the information.

### Technical Solution

An object of the present invention is to provide an avatar image processing unit applicable to various kinds of electronic products for representing information on operation progress or control of the product with an avatar, and a washing machine having the same applied thereto.

The object of the present invention can be achieved by providing an avatar image processing unit including a system microcomputer for controlling operation of entire system of a home appliance, and controlling display of an avatar image proper to an operation progress and control of the home appliance, an avatar information storage unit for storing and providing avatar information under the control of the system microcomputer, and an avatar image unit for displaying the avatar image selected by control of the system microcomputer.

In another aspect of the present invention, an avatar image processing unit includes a system microcomputer for controlling operation of entire system of a home appliance, and controlling display of an avatar image and voice presentation proper to an operation progress of the home appliance, an avatar information storage unit for storing and providing avatar image information and vocal data under the control of the system microcomputer, an avatar image unit for displaying the avatar image selected by control of the system microcomputer, and a voice output unit for presenting state information of an operation progress of the home appliance in a voice.

In this instance, preferably, the voice output unit presents state information related to a movement of the avatar, or representation independent from the movement of the avatar.

The avatar image processing unit further includes an operation display unit for displaying information on operation progress of the home appliance under the control of the system microcomputer, and the avatar image unit and the operation display unit are fabricated of one display panel.

Preferably, the avatar image on the avatar image unit and the operation representation on the operation display unit are displayed on different areas of the display panel at a time, or in a sequence repeatedly according to user's selection.

The avatar image processing unit further includes an operation display unit for displaying information on operation progress of the home appliance under the control of the system microcomputer, and the avatar image unit and the operation display unit are fabricated of separate display panels.

The avatar image processing unit further includes first, and second display operating units for independent operation of the avatar image unit and the operation display unit.

Preferably, the avatar image has a movement controlled in relation to representation on the operation display unit.

Preferably, the avatar image processing unit further includes an exclusive controller provided separate from the system microcomputer user as main means for controlling the home appliance, for controlling processing of the avatar image.

The avatar image processing unit further includes a key input unit having an avatar control key for applying a user's selection signal and a voice presenting control signal to the system microcomputer for processing the avatar image.

The avatar image processing unit further includes a communication interface block for making access to an external device for downloading the avatar image information and the vocal data.

Preferably, the voice output unit presents a voice only of the avatar as a tone color, a pitch of voice, an volume of the voice varied with kinds of the avatar selected.

Preferably, the control for presenting the voice only of the avatar is made at the key input unit by the user's selection.

In another aspect of the present invention, an avatar image processing unit in a laundry machine having a drum for holding laundry and a motor for driving the drum, includes a system microcomputer for controlling loads of the laundry machine including the motor, and controlling display of an avatar image, and a display unit having an avatar image unit for displaying the avatar image selected in correspondence to a load state and operation progress state of the laundry machine under the control of the system microcomputer.

In another aspect of the present invention, an avatar image processing unit in a laundry machine having a drum for holding laundry and a motor for driving the drum, includes a system microcomputer for controlling loads of the laundry machine including the motor, a display microcomputer for controlling display of an avatar image, and a display unit having an avatar image unit for displaying the avatar image selected in correspondence to a load state and operation progress state of the laundry machine under the control of the display microcomputer.

In this instance, the display unit further includes an operation display unit for displaying operation progress information of the laundry machine.

Preferably, the operation display unit and the avatar image unit have screens displayed on one display panel.

Preferably, the avatar image of the avatar image unit and a representation of the operation display unit are displayed on separate areas of the display panel at the same time, or displayed on an entire area of the panel in a sequence, repeatedly.

Preferably, the avatar image unit has a screen of an LCD panel, and the operation display unit has a screen of an LED panel.

The avatar image processing unit further includes first, and second driving units for making independent driving of the avatar image unit and the operation display unit.

Preferably, the system microcomputer controls movement of the avatar in correspondence to an operation state of the laundry machine including washing, spinning, and drying.

Preferably, the system microcomputer controls movement of the avatar in correspondence to a state change of a load unit of the laundry machine.

The avatar image processing unit further includes a key input unit having an avatar control key for inputting a user's selection signal for processing the avatar image.

The avatar image processing unit further includes an avatar information storage unit for storage of the avatar displayed on the avatar image unit.

The avatar image processing unit further includes a communication interface block for making access to an external device for downloading the avatar information.

### Advantageous Effects

The avatar image processing unit and a laundry machine having the same applied thereto have the following advantages.

The avatar image processing unit of the present invention applied to a home appliance enables to represent a basic direction of use, and states of operation progress and control with mobile characters.

The voice presentation related to movement of the avatar enables more accurate transmission of information, which enhances visibility of information to improve information transmission performance, and permits to put emphasis on an entertainment factor of the present consumer trend.

A variety of representation is possible by downloading and storing new avatar from a server accessed with an external device, which permits a variety of operation state representations proper for operation conditions, thereby enhancing competitiveness of the product.

Moreover, the laundry machine having the avatar image processing unit of the present invention applied thereto can represent a basic direction of use, and states of operation progress and control with mobile characters, which enhances visibility of information provision, thereby improving information transmission performance, and permitting to put emphasis on an entertainment factor of the present consumer trend.

Particularly, the control of movement of the avatars selected thus in correspondence to changes of the washing and drying progress states of the laundry machine and operation states of the motor and other load driving unit permits the user to understand the present operation progress state of the laundry machine within a short time period.

### BRIEF DESCRIPTION OF THE DRAWINGS

FIG. 1 illustrates a block diagram of an avatar image processing unit in accordance with a preferred embodiment of the present invention;

FIG. 2 illustrates a block diagram of an avatar image processing unit applied to a laundry machine as an embodiment of the present invention; and

FIG. 3 illustrates a state showing an example of a laundry machine having an avatar image unit of the present invention applied thereto.

### BEST MODE FOR CARRYING OUT THE INVENTION

Other objects, features, and advantages of the present invention will be evident through the following detailed description of embodiments of the present invention.

Preferred embodiments of the avatar image processing unit and a laundry machine having the same applied thereto will be described in detail with reference to the attached drawings.

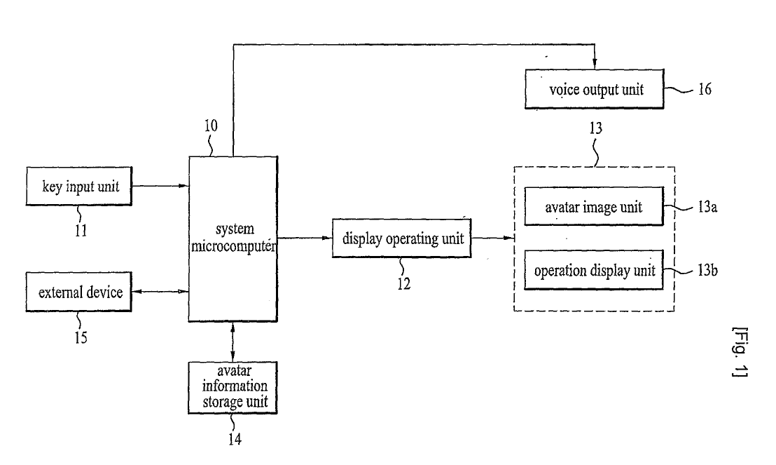

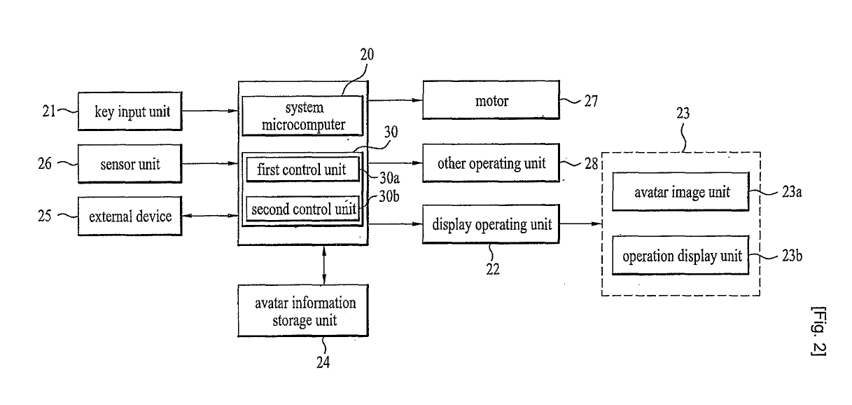

FIG. 1 illustrates a block diagram of an avatar image processing unit in accordance with a preferred embodiment of the present invention, and FIG. 2 illustrates a block diagram of a home appliance having an avatar image processing unit applied thereto, for an example, an image processing unit in a home appliance.

The present invention suggests to utilize a three dimensional character, i.e., an avatar, in representing a direction of use of a product, or a state of operation progress of the product, for enhancing visibility to improve an information transmission performance.

Moreover, a voice output unit is provided for presenting voice independently, or in connection with a movement of the avatar.

An information form presented through the voice output unit is, not only an explanation of an operation state with human voice, but also background music tuned to a movement of the avatar.

Besides the enhancement of visibility, the information transmission by using the avatar permits to enhance consumer's friendliness to the product because an entertainment factor of the present consumer trend can be emphasized.

The avatar, a manifestation or personification, is an animation character serving as a user in a cyber space. As the Internet age opens, the avatar is a graphic icon representing oneself in chatting or so in a three dimension, or virtual reality game, or in a web.

That is, the avatar is a virtual body representing oneself in a virtual society of graphic. Besides chatting or an online game, the fields in which the avatar is in use presently are expanded to shopping malls, virtual education, virtual offices, and so on.

The present invention provides an avatar image processing unit for enabling the user to employ the avatar as a helper in an information transmission process.

The avatar of the present invention performs a particular action in a form which can characterize an operation of a home appliance, or transmits particular information.

The avatar image processing unit of the present invention includes a microcomputer for use as main control means of the home appliance, and controlling an avatar image processing, an avatar image unit for processing and displaying an avatar image under the control of the microcomputer, storage means for storing information on the avatar and voice data of the avatar, and a voice output unit for presenting vocal information to the user independently, or in connection with a movement of the avatar.

It is apparent that, as control means for processing the avatar image, there can be, not the microcomputer of the home appliance, but an exclusive additional controller for processing the avatar image.

A detailed system is as shown in FIG. 1.

The avatar image processing unit includes a system microcomputer 10 for using as main control means of a home appliance, such as a washing machine, a dryer, a dish washer, an air conditioner, so on, and controlling display of a kind of the avatar of user's selection, i.e., processing an image related to the avatar, proper to an operation state of the home appliance and a kind of information to be represented, a key input unit 11 having avatar control keys for inputting a signal of user's selection for processing the avatar image through the system microcomputer 10, such as an avatar selection/erasure signal, or a voice presenting control signal, a display operating unit 12 for providing a driving signal to display a menu and operation state information when operation of the hone appliance is selected, and to display the avatar image, a display unit 13 for displaying the menu and the operation state information when operation of the home appliance is selected, and to display the avatar image, in response to the driving signal from the display operating unit 12, and an avatar information storage unit 14 for storing various kinds of avatar image information and voice data.

Moreover, the present invention may further include a voice output unit 16 for presenting an operation state of the home appliance in a voice independently, or in connection with a movement of the avatar pursuant to a menu or progress when operation of the home appliance is selected.

In this instance, separate from the system microcomputer 10 used as main control means of the home appliance, exclusive control means may be provided for controlling the display operating unit 12 which controls display of a kind of avatar of user's selection, i.e., processing of an avatar related image, proper to an operation state of the home appliance and a kind of information to be represented.

The display unit 13 includes an avatar image unit 13a for displaying the avatar image, and an operation display unit 13b for displaying an operation mode of the home appliance, a remained operation time period, and so on.

The avatar image unit 13a and the operation display unit 13b may be fabricated of one display panel, or may be fabricated of independent panels.

In a case the avatar image unit 13a and the operation display unit 13b are fabricated of independent panels, the avatar image unit 13a is fabricated of an LCD (Liquid Crystal Display) panel, and the operation display unit 13b is fabricated of an LED (Light Emitting Diode; luminescent diode) or an LCD panel.

In a case the avatar image unit 23a and the operation display unit 23b are fabricated of one display panel, the display panel may be designed to provide an avatar image area and an operation display area separately to show the avatar image and the operation at the same time, or may be designed to show the avatar image and the operation on the one display panel in a sequence repeatedly by selection.

Moreover, the display unit 13 may have an environment of use, such as a background color, variable by user's selection.

The avatar image processing unit of the present invention has a communication interface block so that the system microcomputer 10 makes access to an external device, such as a PC, a radio notebook, and a mobile phone connected to a radio network, downloads avatar information, and stores the avatar information in the information storage unit 14.

Of course, if the home appliance has a function for making radio access to a home network, the home appliance may perform the function of searching for the avatar information, downloading and storing the avatar information without a connection cable.

Besides the avatar image information, the avatar information storage unit 14 stores vocal data related to, or independent from, the avatar.

Though FIG. 1 illustrates one block of the display operating unit 12, if the display unit 13 is fabricated of two independent panels of the avatar image unit 13a and the operation display unit 13b, the display operating unit 12 may be fabricated of first, and second display operating units for independent control of the avatar image unit 13a and the operation display unit 13b.

The display operating unit is divided thus for enhancing display performance of the panels.

The avatar image processing unit of the present invention downloads the avatar image information and the vocal data as follows.

Once the system microcomputer 10 makes access to the external device 15 by user's selection through the key input unit 11, search for a desired avatar and generation of a new avatar are performed, and the search and the generation is finished, the avatar image information and the vocal data is downloaded by user's selection, and stored in the avatar information storage unit 14.

The search and generation of the avatar information can be performed by the following various methods.

One of the external devices is made to access to a server which provides an avatar through a network, such as the Internet, for searching for the avatar, or generating a new avatar meeting taste of the user, and storing the avatar in the external device itself. Then, the avatar is downloaded from the external device to the avatar information storage unit 14 through the key input unit 11 of the home appliance.

As another method, the external device is made to access, not to a server which provides an avatar, but to a server of a home appliance manufacturer for searching for the avatar, or generating a new avatar meeting taste of the user, and storing the avatar in the external device itself. Then, the avatar is downloaded from the external device to the avatar information storage unit 14 through the key input unit 11 of the home appliance.

Of course, it is apparent that it is possible to access to an external server directly, not with the external device, but with the key input unit 11 of the home appliance, and search for and generate an avatar while looking at information displayed on the display unit 13 and store the avatar.

To do this, the system microcomputer 10 has a program loaded thereon for displaying the avatar information downloaded thus with an avatar image optimized according to operation progress and control of the home appliance.

The program can be updated by making access to the server operated by the manufacturer.

The avatars downloaded and stored in the avatar information storage unit 14 thus are selected through the key input unit 11 by the user, and the selected avatar is displayed while movement, color, and shape of the selected avatar are varied with an operation state of the home appliance.

Of course, it is apparent that avatars different from one another may be set up according to kinds of information represented.

Then, there is a voice presented in relation to the movement of the avatar, for accurate transmission of an operation state and progress state of the home appliance to the user.

In this instance, it is possible that a tone color, a pitch of voice, an effect sound, and so on of the voice presentation is varied with kinds of the avatar selected thus.

The avatar image processing unit of the present invention, applied to the home appliance, enables the home appliance to display representation of a basic direction of use of the home appliance, and states of an operation progress and control with mobile characters, and steric transmission by using the vocal presentation related to the mobile characters.

FIG. 2 illustrates a block diagram of the avatar image processing unit applied to a laundry machine as an embodiment of the present invention.

In FIG. 2, control means is divided into a system microcomputer for controlling operation of the laundry machine, and a display microcomputer for controlling display of the avatar.

The laundry machine having an avatar image processing unit includes a drum (not shown) for holding laundry, a system microcomputer 20 for applying a control signal to a motor 27 for driving the drum and other operating unit 28, to drive the motor 27, a water supply valve (not shown), a drain valve (not shown), and so on in a sequence to progress washing, and controlling entire system of the laundry machine, a display microcomputer 30 for processing an avatar related image, i.e., display of a kind of avatar of user's selection, proper to an operation state of the laundry machine and a kind of information represented, a key input unit 21 including key input means for user's selection of a washing course set up, and so on, having an avatar control key for inputting a signal of user's selection for processing an avatar image through the display microcomputer 30, for an example, an avatar selection/erasure signal, a sensor unit 26 for sensing a water level, a temperature, and so on for progressing washing, a display operating unit 22 for providing a driving signal to display a menu and operation state information when operation of the laundry machine is selected, and to display the avatar image, a display unit 23 for displaying the menu and the operation state information when operation of the laundry machine is selected, and to display the avatar image, in response to the driving signal from the display operating unit 22, and an avatar information storage unit 24 for storing various kinds of avatar image information.

The display microcomputer 30 includes a first control unit 30a for controlling display of an avatar image unit 23a which displays an avatar image, and a second control unit 30b for controlling display of the operation display unit 23b which displays an operation mode, remained time period, and so of the laundry machine.

In this case, it is preferable that the display operating unit 22 includes a first display operating unit for operating the avatar image unit 23a, and a second display operating unit for operating the operation display unit 23b, for enhancing display performance of the panels.

The display unit 23 includes an avatar image unit 23a for displaying the avatar image, and an operation display unit 23b for displaying an operation mode of the home appliance, a remained operation time period, and so on.

The avatar image unit 23a and the operation display unit 23b may be fabricated of one display panel, or may be fabricated of independent panels.

In a case the avatar image unit 23a and the operation display unit 23b are fabricated of independent panels, the avatar image unit 23a is fabricated of an LCD (Liquid Crystal Display) panel, and the operation display unit 23b is fabricated of an LED (Light Emitting Diode; luminescent diode).

In a case the avatar image unit 23a and the operation display unit 23b are fabricated of one display panel, the display panel is designed to show an avatar image area and an operation display area at the same time, or in a sequence by selection.

Moreover, the display unit 23 can vary a background color according to user's selection.

The laundry machine having an avatar image processing unit of the present invention has a communication interface block (not shown) so that the system microcomputer 20 makes access to an external device 25, such as a PC, radio notebook, and a mobile phone connected to a radio network, downloads avatar information, and stores the avatar information in the information storage unit 24.

In the present invention, a method for downloading an avatar image information and vocal data is the same with the foregoing description.

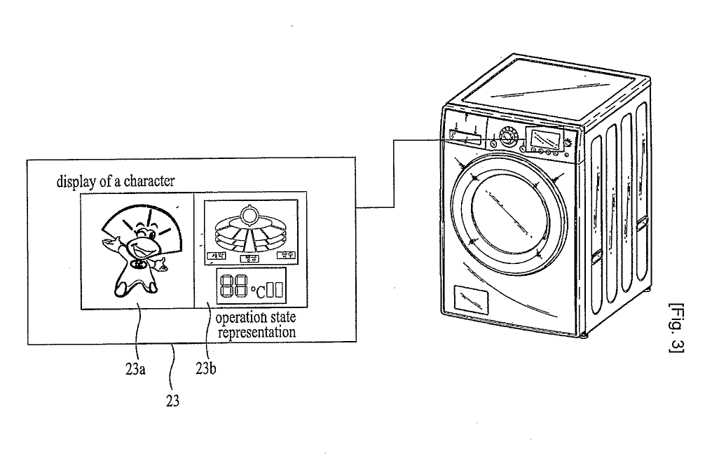

Representation of information with an avatar on a laundry machine having the foregoing avatar image processing unit of the present invention applied thereto is as illustrated in FIG. 3.

FIG. 3 illustrates the avatar image unit 23a and the operation display unit 23b fabricated of one display panel.

As described before, in downloading the avatar information in a laundry machine having the avatar image processing unit of the present invention applied thereto, the laundry machine accesses to the external device 25, downloads the avatar information of the user's selection, and stores the avatar information in the avatar information storage unit 24.

The avatar information storage unit 24 has many kinds of avatars stored therein, which can be selected by the user with the key input unit 21 in correspondence to a particular operation state and course.

The avatars selected thus have movements controlled to represent in correspondence both to washing and drying progress states of the laundry machine and changes of operation states of the motor 27 and the other operating unit 28.

Of course, though not shown, avatars to be set up can be varied with kinds of information to be represented, and basic direction of use and operation and control states of the laundry machine can be represented with mobile characters.

Though not shown, the vocal presentation by the voice output unit can be used in explaining the basic direction of use of the laundry machine in connection with the movement of the avatar.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An avatar image processing unit comprising:
a system microcomputer for controlling operation of entire system of a home appliance, and controlling display of an avatar image proper to an operation progress and control of the home appliance;
an avatar information storage unit for storing and providing avatar information under the control of the system microcomputer; and
an avatar image unit for displaying the avatar image selected by control of the system microcomputer.

2. The avatar image processing unit as claimed in claim 1, further comprising an operation display unit for displaying information on operation progress of the home appliance under the control of the system microcomputer, and the avatar image unit and the operation display unit are fabricated of one display panel.

3. The avatar image processing unit as claimed in claim 2, wherein the avatar image on the avatar image unit and the operation representation on the operation display unit are displayed on different areas of the display panel at a time, or in a sequence repeatedly according to user's, selection.

4. The avatar image processing unit as claimed in claim 1, further comprising an operation display unit for displaying information on operation progress of the home appliance under the control of the system microcomputer, and the avatar image unit and the operation display unit are fabricated of separate display panels.

5. The avatar image processing unit as claimed in claim 4, further comprising first, and second display operating units for independent operation of the avatar image unit and the operation display unit.

6. The avatar image processing unit as claimed in claim 2, wherein the avatar image has a movement controlled in relation to representation on the operation display unit.

7. The avatar image processing unit as claimed in claim 1, further comprising an exclusive controller provided separate from the system microcomputer user as main means for controlling the home appliance, for controlling processing of the avatar image.

8. The avatar image processing unit as claimed in claim 1, further comprising a key input unit having an avatar control key for applying a user's selection signal to the system microcomputer for processing the avatar image.

9. The avatar image processing unit as claimed in claim 1, further comprising a communication interface block for making access to an external device for downloading the avatar information.

10. The avatar image processing unit as claimed in claim 9, wherein the avatar information downloaded at access to the external device through the communication interface block is stored in the avatar information storage unit.

11. An avatar image processing unit comprising:
a system microcomputer for controlling operation of entire system of a home appliance, and controlling display of an avatar image and voice presentation proper to an operation progress of the home appliance;
an avatar information storage unit for storing and providing avatar image information and vocal data under the control of the system microcomputer;
an avatar image unit for displaying the avatar image selected by control of the system microcomputer; and
a voice output unit for presenting state information of an operation progress of the home appliance in a voice.

12. The avatar image processing unit as claimed in claim 11, wherein the voice output unit presents state information related to a movement of the avatar, or representation independent from the movement of the avatar.

13. The avatar image processing unit as claimed in claim 11, further comprising an operation display unit for displaying information on operation progress of the home appliance under the control of the system microcomputer, and the avatar image unit and the operation display unit are fabricated of one display panel.

14. The avatar image processing unit as claimed in claim 13, wherein the avatar image on the avatar image unit and the operation representation on the operation display unit are displayed on different areas of the display panel at a time, or in a sequence repeatedly according to user's selection.

15. The avatar image processing unit as claimed in claim 11, further comprising an operation display unit for displaying information on operation progress of the home appliance under the control of the system microcomputer, and the avatar image unit and the operation display unit are fabricated of separate display panels.

16. The avatar image processing unit as claimed in claim 15, further comprising first, and second display operating units for independent operation of the avatar image unit and the operation display unit.

17. The avatar image processing unit as claimed in claim 13, wherein the avatar image has a movement controlled in relation to representation on the operation display unit.

18. The avatar image processing unit as claimed in claim 11, further comprising an exclusive controller provided separate from the system microcomputer user as main means for controlling the home appliance, for controlling processing of the avatar image.

19. The avatar image processing unit as claimed in claim 11, further comprising a key input unit having an avatar control key for applying a user's selection signal and a voice presenting control signal to the system microcomputer for processing the avatar image.

20. The avatar image processing unit as claimed in claim 11, further comprising a communication interface block for making access to an external device for downloading the avatar image information and the vocal data.

21. The avatar image processing unit as claimed in claim 11, wherein the voice output unit presents a voice only of the avatar as a tone color, a pitch of voice, an volume of the voice varied with kinds of the avatar selected.

22. The avatar image processing unit as claimed in claim 21, wherein the control for presenting the voice only of the avatar is made at the key input unit by the user's selection.

23. An avatar image processing unit in a laundry machine having a drum for holding laundry and a motor for driving the drum, comprising:
a system microcomputer for controlling loads of the laundry machine including the motor, and controlling display of an avatar image; and
a display unit having an avatar image unit for displaying the avatar image selected in correspondence to a load state and operation progress state of the laundry machine under the control of the system microcomputer.

24. The avatar image processing unit as claimed in claim 23, wherein the display unit further includes an operation display unit for displaying operation progress information of the laundry machine.

25. The avatar image processing unit as claimed in claim 24, wherein the operation display unit and the avatar image unit have screens displayed on one display panel.

26. The avatar image processing unit as claimed in claim 25, wherein the avatar image of the avatar image unit and a representation of the operation display unit are displayed on separate areas of the display panel at the same time, or displayed on an entire area of the panel in a sequence, repeatedly.

27. The avatar image processing unit as claimed in claim 24, wherein the avatar image unit has a screen of an LCD panel, and the operation display unit has a screen of an LED panel.

28. The avatar image processing unit as claimed in claim 24, further comprising first, and second driving units for making independent driving of the avatar image unit and the operation display unit.

29. The avatar image processing unit as claimed in claim 23, wherein the system microcomputer controls movement of the avatar in correspondence to an operation state of the laundry machine including washing, spinning, and drying.

30. The avatar image processing unit as claimed in claim 29, wherein the system microcomputer controls movement of the avatar in correspondence to a state change of a load unit of the laundry machine.

31. The avatar image processing unit as claimed in claim 23, further comprising a key input unit having an avatar control key for inputting a user's selection signal for processing the avatar image.

32. The avatar image processing unit as claimed in claim 23, further comprising an avatar information storage unit for storage of the avatar displayed on the avatar image unit.

33. The avatar image processing unit as claimed in claim 23, further comprising a communication interface block for making access to an external device for downloading the avatar information.

34. An avatar image processing unit in a laundry machine having a drum for holding laundry and a motor for driving the drum, comprising:
a system microcomputer for controlling loads of the laundry machine including the motor;
a display microcomputer for controlling display of an avatar image; and
a display unit having an avatar image unit for displaying the avatar image selected in correspondence to a load state and operation progress state of the laundry machine under the control of the display microcomputer.

35. The avatar image processing unit as claimed in claim 34, wherein the display unit further includes an operation display unit for displaying operation progress information of the laundry machine.

36. The avatar image processing unit as claimed in claim 35, wherein the operation display unit and the avatar image unit have screens displayed on one display panel.

37. The avatar image processing unit as claimed in claim 36, wherein the avatar image of the avatar image unit and a representation of the operation display unit are displayed on separate areas of the display panel at the same time, or displayed on an entire area of the panel in a sequence, repeatedly.

38. The avatar image processing unit as claimed in claim 35, wherein the avatar image unit has a screen of an LCD panel, and the operation display unit has a screen of an LED panel.

39. The avatar image processing unit as claimed in claim 35, further comprising first, and second driving units for making independent driving of the avatar image unit and the operation display unit.

40. The avatar image processing unit as claimed in claim 34, wherein the display microcomputer controls movement of the avatar in correspondence to an operation state of the laundry machine including washing, spinning, and drying.

41. The avatar image processing unit as claimed in claim 40, wherein the display microcomputer controls movement of the avatar in correspondence to a state change of a load unit of the laundry machine.

42. The avatar image processing unit as claimed in claim 34, further comprising a key input unit having an avatar control key for inputting a user's selection signal for processing the avatar image.

43. The avatar image processing unit as claimed in claim 34, further comprising an avatar information storage unit for storage of the avatar displayed on the avatar image unit.

44. The avatar image processing unit as claimed in claim 34, further comprising a communication interface block for making access to an external device for downloading the avatar information.

45. The avatar image processing unit as claimed in claim 35, wherein the display microcomputer includes;
a first control unit for controlling operation of the display of the avatar image unit, and
a second control unit for controlling display of the operation display unit.
